(19) United States
(12) Patent Application Publication
(10) Pub. No.: US 2023/0311220 A1
(43) Pub. Date: Oct. 5, 2023

(54) METAL CUTTING INDEXABLE DRILL TOOL

(71) Applicant: AB SANDVIK COROMANT, Sandviken (SE)

(72) Inventor: Håkan CARLBERG, Sandviken (SE)

(21) Appl. No.: 18/013,021

(22) PCT Filed: Apr. 22, 2021
(86) PCT No.: PCT/EP2021/060483

§ 371 Date: Dec. 27, 2022

(30) Foreign Application Priority Data
Jul. 1, 2020 (EP) 20183366.2

(51) Int. Cl. B23B 51/00

(52) U.S. Cl. CPC B23B 51/0008; B23B 2251/406

(57) ABSTRACT

A metal cutting indexable drill tool includes a drill body having a boring shaft. A center drill insert is mounted at a distal end of the boring shaft. A drill flute of the boring shaft is configured to direct and form a chip from the center drill insert, wherein the drill flute has a chip forming surface at a distal end thereof. The chip forming surface is arranged at a distance from a peripheral corner of the center drill insert to a point on a curve formed by the intersection of the chip forming surface and an imaginary inscribed sphere. The radius of the imaginary inscribed sphere, defined by the peripheral corner and the distance divided with the diameter of the drill tool is equal to a chip parameter A, which is indicative of the chip diameter to boring diameter ratio, wherein A is 0.3≤A≤0.5.

### TECHNICAL FIELD

The present invention relates to a metal cutting indexable drill tool, and more particularly to a metal cutting indexable drill tool with a center drill insert.

### BACKGROUND

In modern subtractive manufacturing drilling is an important operation and especially drilling in metal proves to be a demanding operation.

In metal drilling a drill tool with replaceable metal cutting inserts is often used, especially in CNC operations. The drill tool of the previously discussed type comprises an elongated drill body with a mount shank and a boring shaft. In a distal end of the boring shaft, a center insert for cutting material from the center region of the drilled hole, and a peripheral insert for cutting material in the peripheral region of the hole are arranged. In order to achieve a good drilling operation chip evacuation and chip control are of utmost importance for surface finish and drill speed. But chip evacuation and control are also of great importance for process security and reliability. Especially, the chip control and chip evacuation for the center insert proves to be demanding. The chip that is cut by the center insert is in the form of a spiral cone due to the fact that the peripheral end of the edge cuts a longer chip than the center end of the edge of the insert. Another important parameter of chip forming is the length of the chip which preferably is sufficiently long but not too long. If the chip becomes too long the chip may entangle the drill tool and result in poor process security and in surface damages in the drilled hole, and a too short chip also may result in problems with chip evacuation from the drill tool which of course also will have a bad influence on process security and reliability.

It is in the art well known to provide a drill tool with drill flutes for improved chip evacuation and control. This allows a continuous chip to be formed and directed away from the cutting zone. However, the problem with too long chips is not addressed with drill flutes.

Therefore, it still remains a need to further improve the geometry of a metal cutting drill tool to achieve good chip evacuation and to prevent too long chips to be formed.

It is therefore an object of the present invention to present a metal cutting drill tool that allows an improved chip control.

### SUMMARY

According to the present invention, the above mentioned object is achieved by means of a metal cutting indexable drill tool having the features defined in claim 1.

The metal cutting indexable drill tool according to the present invention comprises an elongated drill body having a boring shaft and a mount shank, a center drill insert mounted at a distal end of the boring shaft in an insert seat configured to hold the insert against a bottom of the insert seat. The metal cutting indexable drill tool further comprises a drill flute of the boring shaft configured to direct and form a chip from the center drill insert, wherein the drill flute comprises a chip forming surface at a distal end of the drill flute. The metal cutting indexable drill tool is characterized in that the chip forming surface is perpendicular to the bottom of the insert seat for the center drill insert, and in that the chip forming surface is arranged at a distance X from a peripheral corner of the center drill insert to a point on a curve, which curve is formed by the intersection of the chip forming surface and an imaginary inscribed sphere, wherein the center of the imaginary inscribed sphere coincide with the center of the distal end of the boring shaft, wherein the radius of the imaginary inscribed sphere is defined by the peripheral corner of the insert; and wherein the distance X divided with the diameter of the drill tool Dc is equal to a chip parameter A which is indicative of the chip diameter to boring diameter ratio. The chip parameter A is 0.3≤A≤0.5.

According to one embodiment, the chip parameter A is 0.37≤A. This way a chip with a diameter larger than a minimum value is formed.

According to one embodiment, the chip parameter A is A≤0.42. This allows a chip with a diameter smaller than a maximum value to be formed.

According to one embodiment, said point on the curve is on a midpoint of said curve.

According to one embodiment, the metal cutting indexable drill tool according to any one of the preceding claims, characterized in that said chip forming surface extends a distance w≥Dc/4 in a radial direction relative a longitudinal axis of the metal cutting drill tool), and where Dc is the diameter of the metal cutting drill tool. This way a sufficiently sized chip forming surface is formed.

According to one embodiment, said chip forming surface is perpendicular to the bottom of the insert seat throughout its entire length.

According to one embodiment, the radial distance d1 from the top of the insert to the chip forming surface is d1=Dc·P where P is 0.04≤P≤0.08, and Dc is said diameter of the drill tool. This way efficient chip evacuation is achieved.

According to one embodiment, the radial distance d1 from the top of the insert to the chip forming surface is d1=Dc·P where P is 0.04≤P≤0.06, and Dc is said diameter of the drill tool. This way even more efficient chip evacuation is achieved.

Further advantages of the present invention will appear from the description following below.

### LIST OF DRAWINGS

FIG. 1 is a perspective drawing of a metal cutting indexable drill tool according to an embodiment of the present invention,

FIG. 2 is a top view of the metal cutting indexable drill tool disclosed in FIG. 1, and

FIG. 3 is a perspective view of the distal end of the boring shaft of the metal cutting indexable drill tool disclosed in FIG. 1 and FIG. 2 with an imaginary inscribed sphere.

### DETAILED DESCRIPTION OF EMBODIMENTS

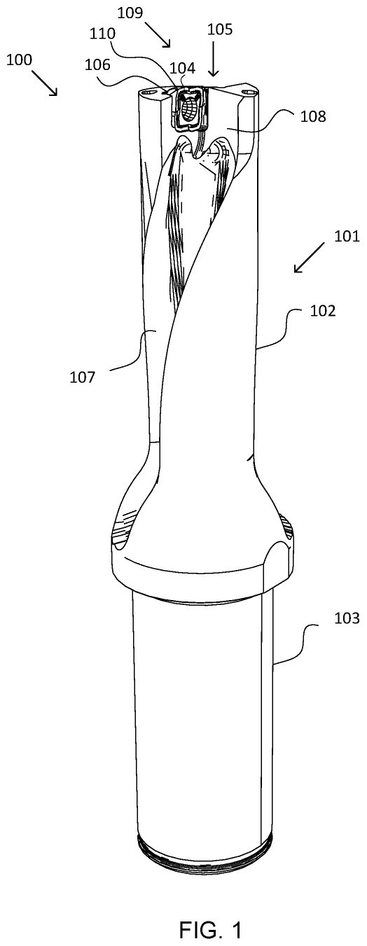

Reference is made to FIG. 1 which shows a metal cutting indexable drill tool 100, comprising an elongated drill body 101 having a boring shaft 102 and a mount shank 103. The metal cutting indexable drill tool further comprises a center drill insert 104 mounted at a distal end 105 of the boring shaft 102 in an insert seat 106 configured to hold the insert against a bottom of the insert seat 106, a drill flute 107 of the boring shaft 102 configured to direct and form a chip from the center drill insert 104. The drill flute 107 comprises a chip forming surface 108 at a distal end 109 of the drill flute 107. The metal cutting indexable drill tool is characterized in that the chip forming surface 108 is perpendicular to the bottom of the insert seat 106 for the center drill insert 104, and in that the chip forming surface 108 is arranged at a distance X from a peripheral corner 110 of the center drill insert 104 to a point 301 on a curve 302, as seen in FIG. 3. The curve is formed by the intersection of the chip forming surface 108 and an imaginary inscribed sphere 309. The center 303 of the imaginary inscribed sphere coincide with the center of the distal end 105 of the boring shaft 102, wherein the radius of the imaginary inscribed sphere is defined by the peripheral corner 110 of the insert 104, and wherein the distance X divided with the diameter of the drill tool Dc is equal to a chip parameter A which is indicative of the chip diameter to boring diameter ratio. The chip parameter A is 0.3≤A≤0.5.

The present inventors have realized that by having such a chip parameter A in the above interval, a favourable chip forming process is achieved and a chip with diameter X=A·Dc is formed. The diameter of the formed chip is the diameter of the helical chip formed in the drilling operation, and this is an important parameter for designing a boring shaft. The diameter of the chip may be used to optimize the amount of material in the boring shaft, which means that a stronger boring shaft may be obtained. This way the boring shaft may be designed for increased strength with maintained chip control and chip evacuation.

In one embodiment, the chip parameter A is 0.37≤A. This way a chip with a diameter larger than a minimum is obtained.

In one embodiment, the chip parameter A is A≤0.42. This way a chip with a diameter smaller than a maximum is obtained.

Now with reference made to FIG. 3 again, which shows the imaginary inscribed sphere 309 arranged at the center of the distal end 105 of the boring shaft 102. The center 303 of the imaginary inscribed sphere 309 coincide with the center of the distal end 105 of the boring shaft 102. The radius of the imaginary inscribed sphere is defined by the peripheral corner 110 of the insert 104. The peripheral corner is the radially peripheral corner and axially peripheral corner relative a longitudinal axis of the drill tool 100. In other words the peripheral corner 110 is the radially outermost and axially outermost corner of the insert 104 relative the drill tool 100 and is thus the active corner of the insert which is closest to the wall of the hole which is formed when drilling. The curve 302 is formed by the intersection of the chip forming surface 108 and the imaginary inscribed sphere 309.

In FIG. 3 said point 301 on the curve 302 is on a midpoint of said curve 302. But due to the geometrical relation between the curve 302 and the peripheral corner 110, the point 301 may be placed anywhere on the curve 302 without significant impact on the length of the distance X as shown. The distance X is the shortest distance from the peripheral corner 110 to the point 301.

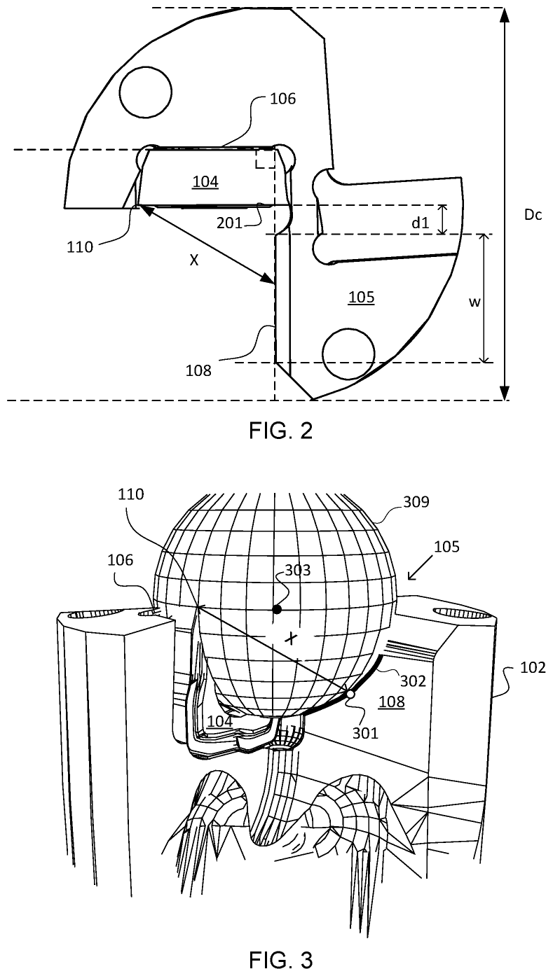

As illustrated in FIG. 2, said chip forming surface 108 extends a distance w≥Dc/4 in a radial direction relative a longitudinal axis of the metal cutting drill tool 100, and where Dc is the diameter of the metal cutting drill tool 100.

FIG. 2 shows that said chip forming surface 108 is perpendicular to the bottom of the insert seat 106 throughout its entire length.

FIG. 2 also shows the radial distance d1 from a top 201 of the insert 104 to the chip forming surface 108. This radial distance d1 is d1=Dc·P where P is 0.04≤P≤0.08, and Dc is said diameter of the drill tool 100. This distance d1 is important for chip evacuation and P is preferably 0.04≤P≤0.06.

1. A metal cutting indexable drill tool comprising:
an elongated drill body having a boring shaft and a mount shank;
a center drill insert mounted at a distal end of the boring shaft in an insert seat configured to hold the insert against a bottom of the insert seat; and
a drill flute of the boring shaft configured to direct and form a chip from the center drill insert, wherein the drill flute includes a chip forming surface at a distal end of the drill flute, wherein the chip forming surface is perpendicular to the bottom of the insert seat for the center drill insert, and wherein the chip forming surface is arranged at a distance X from a peripheral corner of the center drill insert to a point on a curve, which curve is formed by the intersection of the chip forming surface and an imaginary inscribed sphere, wherein a center of the imaginary inscribed sphere coincides with a center of the distal end of the boring shaft, wherein a radius of the imaginary inscribed sphere is defined by the peripheral corner of the insert, wherein the distance X divided with a diameter of the drill tool Dc is equal to a chip parameter A, which is indicative of a chip diameter to boring diameter ratio, and wherein the chip parameter A is 0.3≤A≤0.5.

2. The metal cutting indexable drill tool according to claim 1, wherein the chip parameter A is 0.37≤A.

3. The metal cutting indexable drill tool according to claim 1, wherein the chip parameter A is A≤0.42.

4. The metal cutting indexable drill tool according to claim 1, wherein said point on the curve is on a midpoint of said curve.

5. The metal cutting indexable drill tool according to claim 1, wherein said chip forming surface extends a distance≥Dc/4 in a radial direction relative a longitudinal axis of the metal cutting drill tool, and where Dc is the diameter of the metal cutting drill tool.

6. The metal cutting indexable drill tool according to claim 1, wherein said chip forming surface is perpendicular to the bottom of the insert seat throughout its entire length.

7. The metal cutting indexable drill tool according to claim 1, wherein a radial distance d1 from a top of the insert to the chip forming surface is d1=Dc·P, where P is 0.04≤P≤0.08, and Dc is said diameter of the drill tool.

8. The metal cutting indexable drill tool according to claim 1, wherein a radial distance d1 from a top of the insert to the chip forming surface is d1=Dc·P, where P is 0.04≤P≤0.06, and Dc is said diameter of the drill tool.
